(19) United States
(12) Patent Application Publication
(10) Pub. No.: US 2022/0413603 A1
(43) Pub. Date: Dec. 29, 2022

(54) MULTIPLEXED DIFFRACTIVE ELEMENTS FOR EYE TRACKING

(71) Applicant: Microsoft Technology Licensing, LLC, Redmond, WA (US)

(72) Inventors: Robert Thomas HELD, Seattle, WA (US); Andreas GEORGIOU, Cambridge (GB); Bernard Charles KRESS, Redwood City, CA (US); Joel Steven KOLLIN, Seattle, WA (US)

(73) Assignee: Microsoft Technology Licensing, LLC, Redmond, WA (US)

(21) Appl. No.: 17/359,214

(22) Filed: Jun. 25, 2021

(51) Int. Cl. G06F 3/01; G02B 27/01; G02B 27/42; H04N 5/225

(52) U.S. Cl. CPC G06F 3/013; G02B 27/0172; G02B 27/0179; G02B 27/4205; H04N 5/2256; G02B 2027/0187

(57) ABSTRACT

Examples are provided related to using multiplexed diffractive elements to improve eye tracking systems. One example provides a head-mounted display device comprising a see-through display system comprising a transparent combiner having an array of diffractive elements, and an eye tracking system comprising one or more light sources configured to direct light toward an eyebox of the see-through display system, and also comprising an eye tracking camera. The array of diffractive elements comprises a plurality of multiplexed diffractive elements configured to direct images of a respective plurality of different perspectives of the eyebox toward the eye tracking camera.

### BACKGROUND

A computing system, such as a head-mounted display device (HMD), may employ an eye tracking sensor as a user input mechanism. An eye tracking sensor can be used to determine a gaze direction of an eye of a user, which can be used to identify objects, such as user interface objects, in the determined gaze direction.

### SUMMARY

Examples are provided related to using eye tracking systems comprising multiplexed diffractive elements. One example provides a head-mounted display device comprising a see-through display system including a transparent combiner having an array of diffractive elements. The head-mounted display device also includes an eye tracking system comprising one or more light sources configured to direct light toward an eyebox of the see-through display system, and an eye tracking camera. The array of diffractive elements comprises a plurality of multiplexed diffractive elements configured to direct images of a respective plurality of different perspectives of the eyebox toward the eye tracking camera.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows an example head-mounted display device comprising a see-through display.

FIG. 2 shows a block diagram of an example head-mounted display device comprising an eye tracking system.

FIG. 3 shows an example eye tracking system comprising a holographic optical element including reflective multiplexed holograms configured to direct images of an eyebox from different perspectives toward a camera.

FIG. 4 shows an example eye tracking system comprising a waveguide and transmissive multiplexed holograms to direct images of an eyebox from different perspectives toward a camera.

FIG. 5A shows an example eye tracking system comprising a waveguide and multiplexed holograms to direct an image of an eyebox to a plurality of different locations on an image sensor.

FIG. 5B shows a schematic depiction of the image sensor of FIG. 5A, and illustrates the locations at which the image of the eyebox of FIG. 5A are incident on the sensor.

FIG. 6 shows an example eye tracking system comprising a holographic optical element including reflective multiplexed holograms to direct light from an illumination source toward an eyebox from different perspectives.

FIG. 7 shows an example eye tracking system comprising a waveguide and transmissive multiplexed holograms to direct light from an illumination source toward an eyebox from different perspectives.

FIG. 8 shows a flow diagram of an example method for directing images of different perspectives of an eyebox toward a camera using multiplexed holograms.

FIG. 9 shows a flow diagram of an example method for directing images of an eyebox toward different locations on a camera using multiplexed holograms.

FIG. 10 shows a flow diagram for an example method for using multiplexed holograms to form virtual light sources for eye tracking.

FIG. 11 shows a block diagram of an example computing system.

### DETAILED DESCRIPTION

As mentioned above, a computing system may utilize an eye-tracking system to sense a user's gaze direction as a user input modality. Based on eye-tracking sensor data and one or more anatomical models to account for such parameters as eye and head geometries, an eye-tracking system can project a gaze line that represents a gaze direction from each sensed eye. The computing system then can use the resulting gaze direction(s) to identify, for example, a displayed virtual object that the gaze line from each eye intersects. Further, in the case of a see-through head-mounted augmented reality (AR) display system, image data from an outward-facing image sensor calibrated to the eye-tracking system can be used to identify any real objects in the real-world scene intersected by the gaze lines. Eye tracking can be used as an input mechanism or used to augment another input such as user input commands made via speech, gesture, or button.

An eye tracking system may comprise one or more illumination sources and one or more cameras. The one or more illumination sources are configured to direct light (e.g., infrared light) toward the cornea of the eye to produce glints (reflections from the cornea) that are imaged by the one or more cameras. Image data from each eye tracking camera is analyzed to determine the location of retinal reflections, the location of glint from each illumination source, and a location of the pupil, which may be used to determine a gaze direction.

As mentioned above, some HMDs are configured as see-through augmented reality display devices. Such devices may place illumination sources and eye tracking cameras in the periphery of a field of view to avoid obstructing a user's view of a real-world background. However, such peripheral camera placement produces oblique images of the user's eyes, which may pose problems for detecting some gaze directions. Furthermore, facial features (e.g., eyelashes, cheeks, etc.) can occlude the view of the eye when imaged from large oblique angles. Similarly, light from peripherally located illumination sources may be occluded by such facial features. For example, an obliquely placed illumination source may illuminate eyebrows instead of producing eye glints in some instances.

Such issues with peripheral light source and camera placement can pose particular difficulties when designing lower profile HMDs that are designed to be worn closer to the face (e.g. a device having a sunglasses form factor). In such a device, display hardware may be moved closer to the face relative to larger form factor devices. However, this moves illumination sources and cameras closer to the face as well, which may result in larger oblique angles and worse occlusion from facial features. Additionally, camera performance may degrade at closer distances and larger oblique angles.

Accordingly, examples are disclosed that relate to using a transparent combiner comprising an array of diffractive elements with multiplexed diffractive elements to help address such problems with eye tracking cameras and light sources positioned at oblique angles to an eye. In some examples, the multiplexed diffractive elements are configured to direct images of different perspectives of an eyebox to the camera (a region of space corresponding to an intended location of a user's eye during device use). As the array of diffractive elements is located on the transparent combiner to be in positioned in front of a user's eye, the array may avoid the possible occlusion problems encountered by an obliquely positioned eye tracking camera, as when one perspective is occluded, another perspective may provide an unoccluded view of the eye. In other examples, multiplexed diffractive elements are configured to direct an image of the eye to a plurality of different locations on the image sensor of the eye tracking camera, such that the system may still track the eye if one image of the plurality of images moves partially or fully off the image sensor. While various examples disclosed herein are discussed in the context of a holographic optical element (HOE) comprising multiplexed holograms, it will be understood that any suitable array of diffractive elements comprising multiplexed diffractive elements may be utilized, such as HOEs, diffractive phase gratings, metasurfaces, geometric phase gratings/holograms, diffractive optical elements (DOEs), and surface relief gratings/holograms.

Examples are also disclosed that relate to using multiplexed diffractive elements to direct light from an illumination source toward an eyebox from different perspectives. As one such example, an HMD comprises a transparent combiner having an array of diffractive elements comprising multiplexed diffractive elements. The multiplexed diffractive elements are configured to form one or more virtual light sources from an illumination source, and to direct light from the one or more virtual light sources toward the eyebox. Instead of illuminating an eye from primary illumination sources located at oblique angles, the multiplexed diffractive elements may illuminate the eye with virtual light sources located at frontal perspectives, which may help avoid occlusion from facial features.

The term “transparent combiner” and the like as used herein represent an optical component configured to be positioned in front of the eye to allow a user to view both a real-world background and to provide a path between an eyebox and an eye tracking system component (e.g. a camera and/or illumination source) via the transparent combiner. In some examples, a transparent combiner may have some opacity, whether at select wavelengths or broadly across the visible spectrum, yet still permit a real-world background to be viewed. In some examples, a same transparent combiner may be used to deliver images for display and for eye tracking, while in other examples different transparent combiners may be used for eye tracking and for image display.

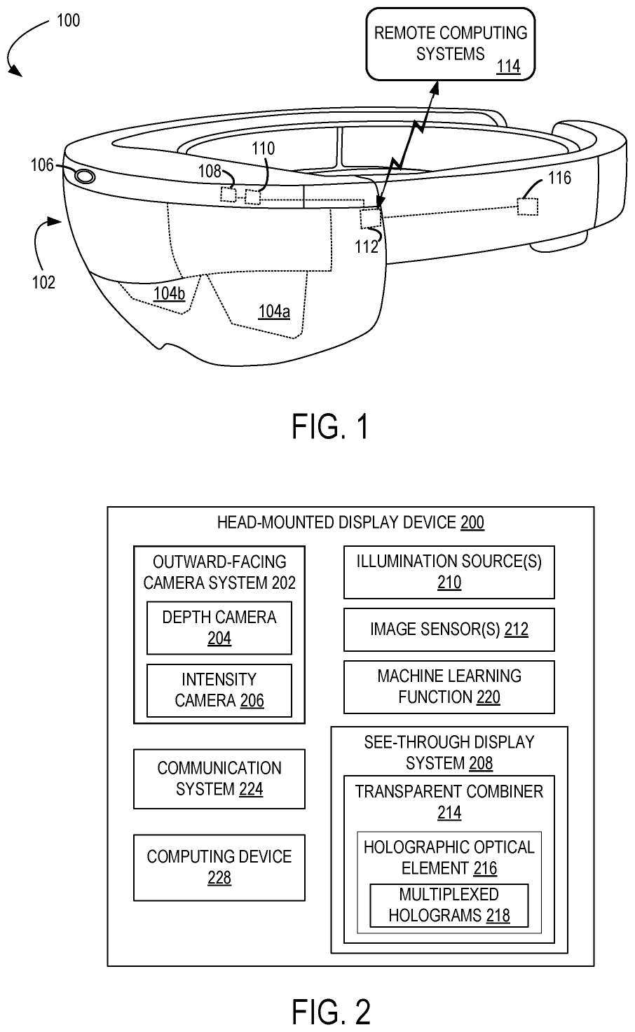

FIG. 1 shows an example HMD device 100 including a display device 102 positioned near a wearer's eyes. Display device 102 includes left-eye and right-eye see-through displays 104a, 104b each comprising transparent combiners positioned to display virtual imagery in front of a view of a real-world environment to enable augmented reality applications, such as the display of mixed reality imagery. The transparent combiner can include waveguides, prisms, and/or any other suitable transparent element configured to combine real world imagery and virtual imagery, and each transparent combiner incorporates an HOE comprising multiplexed holograms, as described in more detail below. In other examples a display device may include a single see-through display extending over one or both eyes, rather than separate right and left eye displays. Display device 102 includes an image producing system (for example a laser scanner, a liquid crystal on silicon (LCoS) microdisplay, a transmissive liquid crystal microdisplay, an organic light emitting device (OLED) microdisplay, or digital micromirror device (DMD)) to produce images for display. Images displayed via see-through displays 104a, 104b may comprise stereo images of virtual objects overlayed on the real-world scene such that the virtual objects appear to be present in the real-world scene.

HMD device 100 also comprises an outward-facing camera system, depicted schematically at 106, which may comprise one or more of a depth camera system (e.g., time-of-flight camera, structured light camera, or stereo camera arrangement), an intensity camera (RGB, grayscale, and/or infrared), and/or other suitable imaging device. Imagery from outward-facing camera system 106 can be used to form a map of an environment, such as a depth map.

HMD device 100 further comprises an eye tracking system to determine a gaze direction of one or both eyes of a user. The eye tracking system comprises, for each eye, an eye tracking camera (illustrated schematically for a left eye at 108) and an illumination system (illustrated schematically for a left eye at 110), the illumination system comprising one or more light sources configured to form glints of light on a cornea of a user. A right eye tracking system may have a similar configuration. As described in more detail below, one or more of light from illumination system 110 to an eyebox of the HMD device 100, and images of the eyebox to camera 108, are diffracted by the multiplexed hologram of transparent combiner of see-through display 104a to form light rays extending between the illumination system 110 and/or the camera 108 having two or more different perspectives relative to an eye of a user wearing the HMD device 100.

HMD device 100 also comprises a controller 112 and a communication subsystem for communicating via a network with one or more remote computing systems 114. Controller 112 comprises, among other components, a logic subsystem and a storage subsystem that stores instructions executable by the logic subsystem to control the various functions of HMD device 100, including but not limited to the eye tracking functions described herein. HMD device 100 further may comprise an audio output device 116 comprising one or more speakers configured to output audio content to the user. In some examples, a speaker may be positioned near each ear. In other examples, HMD device 100 may connect to external speakers, such as ear buds or headphones.

FIG. 2 shows a block diagram of an example HMD device 200 comprising an eye tracking system. HMD device 100 is an example of HMD device 200. As described above with regard to FIG. 1, HMD device 200 comprises an outward-facing camera system 202 including a depth camera 204 and/or one or more intensity cameras 206. HMD device 200 also comprises a see-through display system 208, and an eye tracking system including one or more illumination sources 210, one or more image sensors 212 each configured to capture images of an eye of the user positioned in an eyebox of the HMD device 200, and a transparent combiner 214 comprising a holographic optical element (HOE) 216. In other examples, HOE 216 may comprise any suitable flat, nominally transparent diffractive element configured to redirect light.

Illumination source(s) 210 may comprise any suitable light source, such as an infrared light emitting diode (IR-LED) or laser. In some examples, each illumination source comprises a vertical-cavity surface-emitting laser (VCSEL).

As mentioned above, transparent combiner 214 is configured to provide an optical path between an eyebox of HMD device 200 and an image sensor 212 and/or illumination source 210. In various embodiments, the transparent combiner 214 may comprise a waveguide, a prism, or a transparent substrate that supports the HOE 216.

HOE 216 comprises multiplexed holograms 218 with angular and wavelength selectivity. Wavelength selectivity may provide multiplexed holograms that diffract IR light while being relatively insensitive to visible light, while angular sensitivity limits a range of incident light angles that are diffracted by the HOE. In some examples, the multiplexed holograms may comprise volumetric refractive index gratings, and may be formed using any suitable material. Example materials include light-sensitive self-developing photopolymer films, multicolor holographic recording films, holographic recording polymers, and transparent holographic ribbons.

As mentioned above, multiplexed holograms 218 may perform various functions, including directing different perspectives of an eyebox toward an image sensor, directing a same perspective of the eyebox to a plurality of different locations on an image sensor, and/or forming one or more virtual light sources from an illumination source to provide glint light from different perspectives for eye tracking. In some examples, images of different perspectives of an eyebox may be directed to overlapping areas on an image sensor. Thus, in some examples, the eye tracking system may comprise an optional trained machine learning function 220 to process image data. A machine learning function may facilitate the processing of image data capturing overlapping images of an eyebox from different perspectives, and may output information such as a probable identification of each imaged glint (e.g. a light source identification and perspective identification for each imaged glint), a probable identification of an imaged retinal reflection, or even a likely gaze direction. In some examples, a machine learning function also may be configured to analyze eye tracking image data even where multiple perspectives are not overlapping. Machine learning function 220 may comprise any suitable algorithm, such as a convolutional neural network (CNN) and/or deep neural network (DNN). Machine learning function 220 may be trained using a training set of image data and associated ground truth eye position data.

HMD device 200 further comprises a communication system 224 to communicate with one or more remote computing systems. HMD device 200 also comprises a computing device 228 comprising computing hardware such as storage and one or more logic devices. The computing device 228 may store instructions executable by the computing system to perform various functions, including but not limited to those described herein that relate to eye tracking. Example computing systems are described in more detail below.

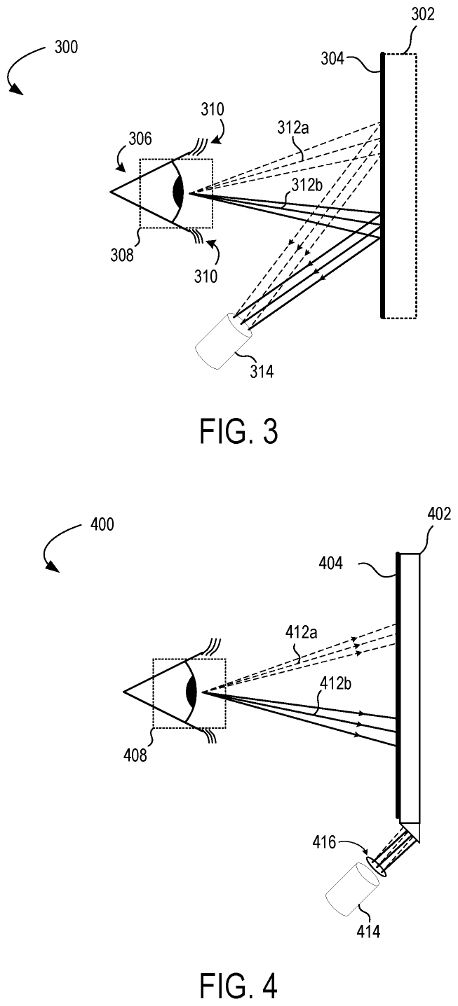

FIG. 3 shows an example eye tracking system 300 comprising a transparent combiner 302 including a HOE 304. As described above, it may be difficult for a camera placed at a large oblique angle to acquire suitable images of a user's eye 306 positioned in an eyebox 308 for eye tracking. Accordingly, HOE 304 comprises multiplexed holograms configured to direct images of eyebox 308 from two different perspectives—one represented by dashed rays (e.g. ray 312a) and one represented by solid rays (e.g. ray 312b) toward a camera 314. The use of HOE 304 positioned on a transparent combiner 302 allows the eye to be imaged from a more direct perspective than the use of an obliquely positioned camera. Furthermore, the use of multiplexed holograms provides different perspectives of the eye 306 positioned in the eyebox 308, thereby reducing the risk of image occlusion, as if one perspective is occluded (e.g. by eyelashes 310), another perspective may be unoccluded. The multiplexed holograms of HOE 304 may have any suitable wavelength and angular selectivity. In some examples, the HOE may have a wavelength selectivity narrowly centered on the wavelength of infrared light used by an illumination source (not shown in FIG. 3), thereby allowing visible light to pass through without diffraction. Likewise, in some examples, the multiplexed holograms may comprise an angular selectivity of 15°, 10°, or even 5° or less. In some examples, a plurality of multiplexed holograms each comprising a different angular selectivity may be used. Further, the angular selectivity of one or more of the multiplexed holograms may vary across the eyebox in some examples.

In the depicted example, HOE 304 comprises optical power configured to provide collimated images to camera 314. In other examples, any other suitable optical power may be encoded in an HOE. Further, as mentioned above, the images of eyebox 308 may be incident on the image sensor of camera 314 in an overlapping arrangement. As such, image sensor data from camera 314 may be transmitted to a processor, which may, for example, input the image sensor data into a trained machine learning function to disambiguate the images by identifying imaged glints (e.g. by a probability that a detected glint is associated with a selected light source and selected perspective), and/or to predict a gaze direction.

The example shown in FIG. 3 utilizes reflective holograms. In other examples, transmissive holograms may be used. FIG. 4 shows an example eye tracking system 400 comprising a transparent combiner having a waveguide 402. A HOE 404 comprises transmissive multiplexed holograms configured to incouple light into waveguide 402, which directs images of eyebox 408 from two perspectives 412a, 412b towards camera 414 via total internal reflection. In some examples, the multiplexed holograms are configured to collimate image light received from eyebox 408 for propagation through the waveguide to a camera lens 416 for imaging.

In other examples comprising a waveguide combiner, the multiplexed holograms may not collimate light as the light is incoupled into the waveguide. In such an example, the multiplexed holograms and waveguide are configured to redirect the different perspective images with a same number of bounces within the waveguide. Likewise, in other examples, a reflective HOE may be used in combination with a waveguide to couple light into the waveguide for eye tracking.

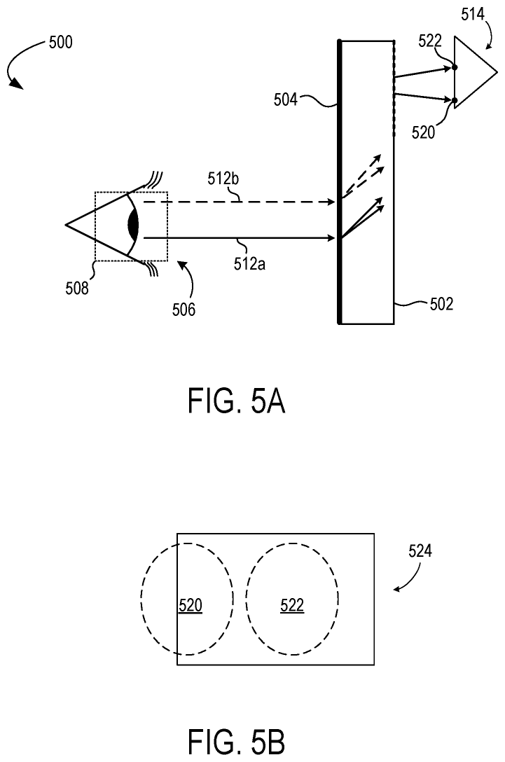

Some HMDs may utilize a relatively small area image sensor. In some such devices, there may be a risk that an image of a glint or pupil may move beyond an edge of the image sensor as the eye moves, thereby impacting eye tracking performance. Thus, in such an HMD, a transparent combiner comprising multiplexed holograms may be configured to direct an image of the eyebox to two or more different locations on an image sensor. As one image moves beyond an edge of the image sensor, the other may move fully onto the image sensor, thereby preserving eye tracking performance. FIG. 5A shows such an example eye tracking system 500. Eye tracking system 500 comprises a see-through display with a transparent combiner in the form of a waveguide 502. The transparent combiner further includes a HOE 504 comprising multiplexed holograms configured to direct an image of an eyebox 508 to a first location 520 and a second location 522 on an image sensor of camera 514. This is indicated by the splitting of ray 512a into two rays within waveguide 502, which are imaged at locations 520 and 522. In this manner, the same perspective is imaged at two locations on the image sensor, or possibly more depending upon how many multiplexed holograms are encoded in the HOE 504.

FIG. 5B shows a schematic depiction of an image sensor 524, and illustrates an image corresponding to ray 512a as imaged at location 520 and location 522 of FIG. 5A. Here, the image at location 520 is partially off beyond an edge of the image sensor. However, the image at location 522 is fully on the image sensor. Thus, by projecting an image to different locations on an image sensor, eye tracking system 500 may avoid problems with one image moving partially or fully beyond an edge of the image sensor.

In some examples, an HOE such as HOE 504 may be used to create a defocused or distorted copy of the eye at a shifted location on an image sensor. While this may appear to corrupt the image, due to redundancy in the image the use a defocused or distorted image may enable camera 514 (and eye tracking software) to extract more information about the eye. As one example, two copies of an image of an eye may be imaged at shifted locations on an image sensor (e.g. image sensor 514), but with each copy having a different focal distance. This may increase the “depth of focus” of the device and potentially improve overall eye tracking.

In some examples, eye tracking system 500 may expand eyebox 508 by imaging multiple points in the eyebox that are laterally shifted relative to each other. As shown schematically by rays 512a and 512b, the multiplexed holograms may direct two (or more) images corresponding to ray 512a, and two (or more) images corresponding to ray 512b, onto the image sensor. In this case, the two images corresponding to ray 512a and the two images corresponding to ray 512b may be imaged at overlapping locations on the image sensor. As discussed above, a trained machine learning function may be employed to process image data from the image sensor and determine a location of a pupil of eye 506, wherein the trained machine learning function may be trained using labeled image data comprising overlapping images corresponding to an eye imaged using HOE 504.

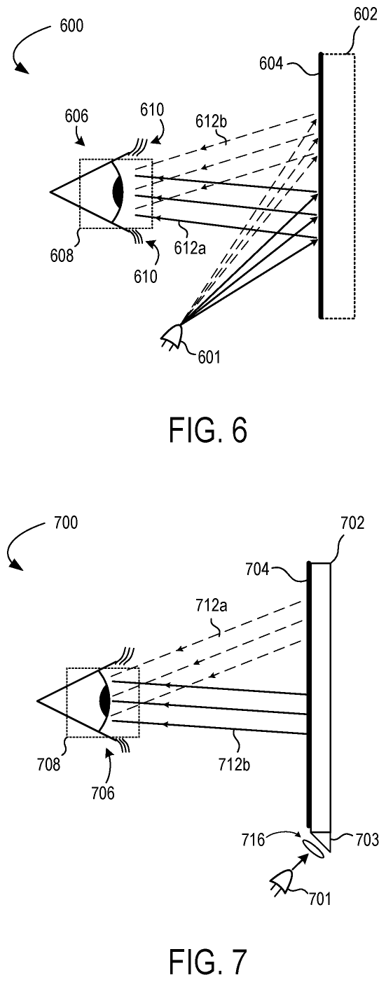

A holographic element comprising multiplexed holograms can also be used to form virtual light sources and illuminate an eyebox from different perspectives. This may allow the formation of a greater number of glints on a cornea using a lesser number of physical light sources, and may allow light for a selected glint location to be directed toward the eye from a plurality of different directions. FIG. 6 shows an example eye tracking system 600 comprising an illumination source 601 and a transparent combiner 602 having a HOE 604. HOE 604 comprises two multiplexed holograms configured to direct two virtual light sources (represented by rays 612a, 612b) toward an eye 606 of a user (positioned in an eyebox 608) via light received from illumination source 601. In other examples, any suitable plurality of multiplexed holograms may be used. As such, the number of virtual light sources may be greater than or equal to the number of physical light sources. While one illumination source 601 is depicted in FIG. 6, any suitable number of physical illumination sources may be used. As shown in FIG. 6, the virtual light sources formed by the multiplexed holograms can direct light for a glint location from different perspectives on eye 606, which may help avoid occlusion from eyelashes 610 and/or other facial features. In other examples, any other suitable array of diffractive elements comprising multiplexed diffractive elements may be used to direct virtual light sources toward an eye.

FIG. 7 shows another example eye tracking system 700 configured to form virtual light sources via an HOE on a transparent combiner. Eye tracking system 700 comprises an illumination source 701, optional lens 716, and a transparent combiner having a waveguide 702. Light from illumination source 701 enters the waveguide at incoupling element 703, is outcoupled at HOE 704, and directed towards an eyebox 708. In this example, HOE 704 comprises two transmissive multiplexed holograms configured to form virtual light sources (represented by rays 712a, 712b) that form glints from different perspectives on an eye 706 located in the eyebox 708. In other examples, any other suitable plurality of multiplexed holograms may be used to form any other suitable number of virtual light sources.

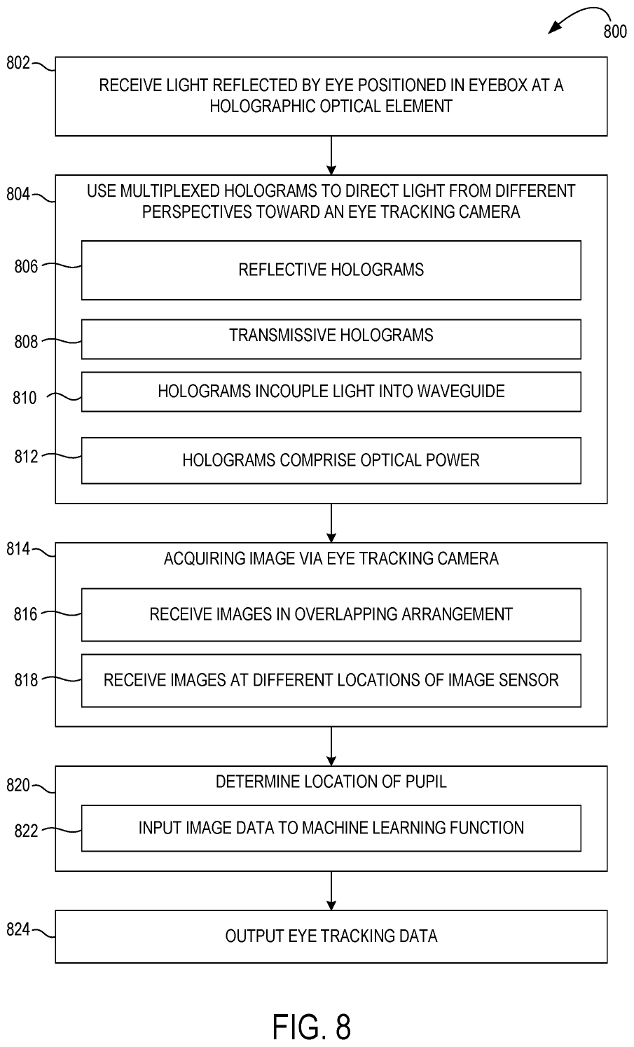

FIG. 8 shows an example method 800 for imaging different perspectives of an eyebox in an eye tracking system via the use of a HOE comprising multiplexed holograms on a transparent combiner. At 802 the method comprises receiving reflected glint light from an eye positioned in an eyebox at a holographic optical element. The holographic optical element comprises a plurality of multiplexed holograms, and each multiplexed hologram receives light from a different perspective of the eye. At 804 the method further comprises using the multiplexed holograms to direct the light to an eye tracking camera. In some examples, at 806, the method comprises diffracting light using reflective holograms. In other examples, at 808, the method comprises diffracting light using transmissive holograms. Further, in some examples, at 810, the holograms are configured to incouple light into a waveguide, wherein the waveguide transmits the images to the eye tracking camera, while in other examples a free space arrangement is used, as opposed to waveguide. In some examples, at 812, the holograms comprise optical power and are configured, for example, to collimate the light that is directed to the eye tracking camera.

Continuing, method 800 further comprises, at 814, acquiring an eye tracking image via the light received from the multiplexed holograms at the eye tracking camera. In some examples, at 816, the images of different perspectives of the eyebox are received in an overlapping arrangement. Likewise, in some examples, at 818, images are received at different locations on the image sensor of the eye tracking camera.

Method 800 further comprises, at 820, determining a location of a pupil of an eye. In some examples, at 822, the method comprises inputting image data into a trained machine learning function to determine the location of the pupil, while in other examples geometric computational methods may be used. Method 800 further comprises, at 824, outputting eye tracking data. For example, the eye tracking data may be used to determine a gaze direction of the user, which may then be output to various computer applications and/or services that utilize gaze data.

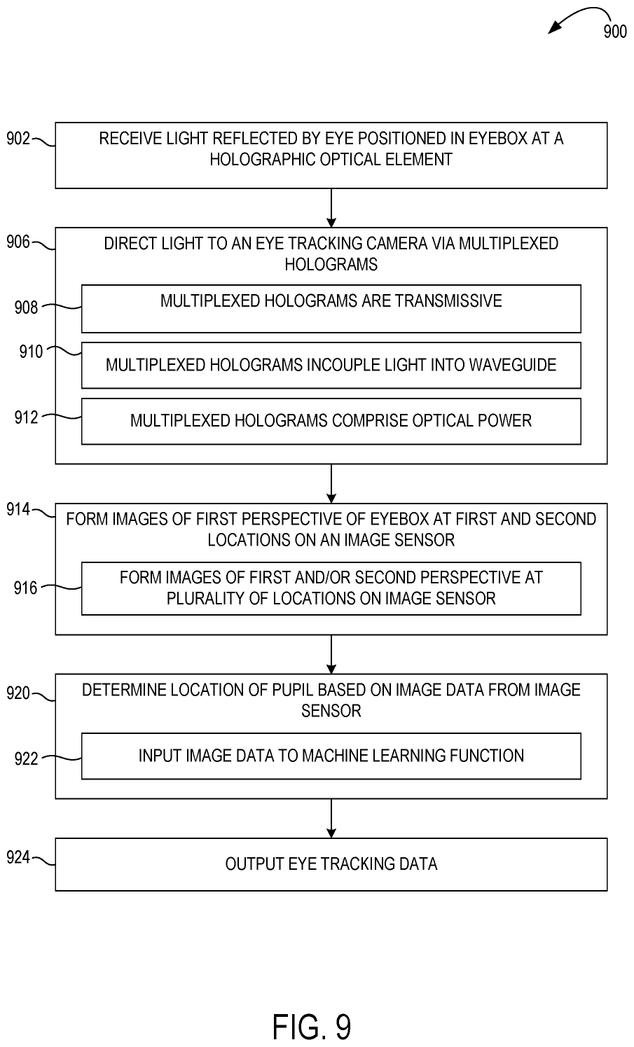

FIG. 9 shows a flow diagram of an example method 900 for imaging an eyebox at different locations on an image sensor via the use of an HOE comprising multiplexed holograms. At 902, the method comprises receiving light reflected by an eye positioned in an eyebox at a holographic optical element comprising multiplexed holograms. Method 900 further comprises, at 906, directing the light to an eye tracking camera via diffraction by the multiplexed holograms. The multiplexed holograms are configured to direct images of a same perspective of the eyebox to different locations on an image sensor. In some examples, at 908, the method comprises diffracting light using transmissive holograms, while in other example the light is diffracted using reflective holograms. Further, in some examples, at 910, the multiplexed holograms incouple light into a waveguide, while in other examples a free-space arrangement, without a waveguide, may be used. Also, in some examples, at 912, the multiplexed holograms comprise optical power, for example, to collimate the light.

Method 900 further comprises, at 914, forming images of a same perspective of the eyebox at first and second locations on an image sensor of the eye tracking camera. In some examples, at 916, the method comprises forming a plurality of images of each of a plurality of different perspectives of the eyebox. In such an example, the plurality of images of each perspective may be spatially separated, but may overlap with images of other perspectives.

Method 900 further comprises, at 920, determining the location of a pupil based on image data from the image sensor. In some examples, at 922, the method comprises inputting the image data from the image sensor into a trained machine learning function. At 924, the method comprises outputting the eye tracking data. For examples, the method may comprise outputting a pupil location to a service or software application to determine a gaze direction.

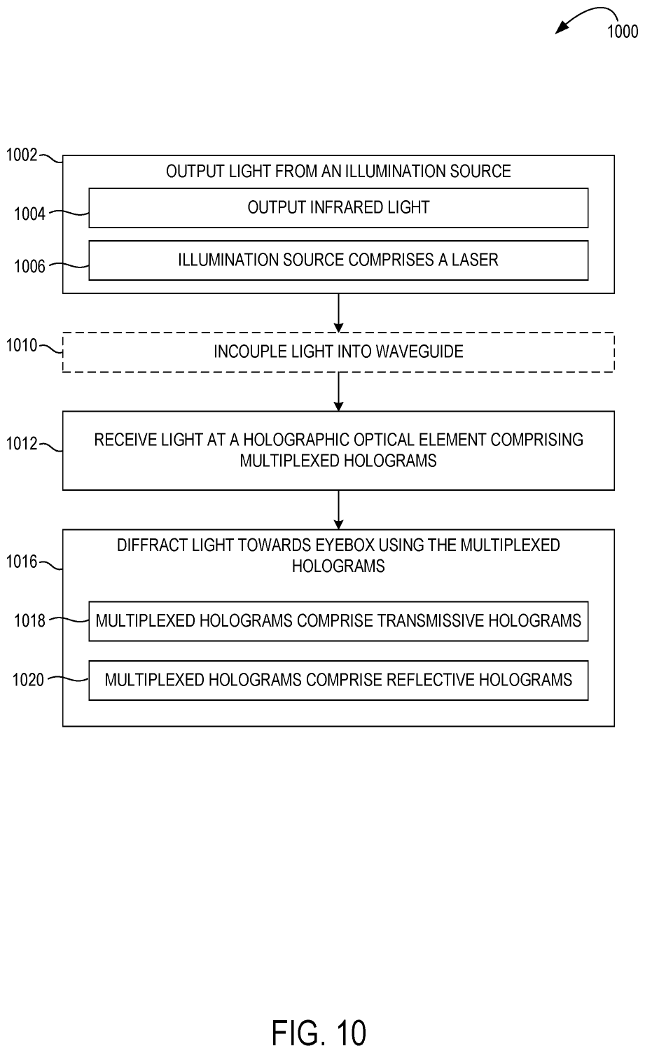

FIG. 10 shows a flow diagram of an example method 900 for forming virtual light sources with multiplexed holograms, and illuminating an eye with the virtual light sources. Method 1000 may be implemented on a device comprising an eye tracking system, such as HMD device 100 or HMD device 200. At 1002, method 1000 comprises outputting light from an illumination source. In some examples, at 1004, the method comprises outputting IR light, while in other examples visible light may be used. Further, in some examples, at 1006, the illumination source is a laser (e.g. a VCSEL), while in other examples another suitable illumination source may be used.

In some examples, at 1010, the light is incoupled into a waveguide. In some examples, the incoupling optical element is configured to have optical power, for example to collimate the light.

At 1012, method 1000 further comprises receiving the light at a holographic optical element comprising multiplexed holograms. The holographic optical element may be allocated on a transparent combiner, such as the waveguide of 1010, or another suitable optical structure (e.g. a prism or transparent substrate).

At 1016, the method comprises diffracting the light towards an eyebox using the multiplexed holograms, thereby forming virtual light sources to provide glint light to the eyebox from different perspectives. In some examples, at 1018, the multiplexed holograms comprise transmissive holograms. For example, transmissive holograms may be used to outcouple light from a waveguide. Likewise, in some examples, at 1020, the multiplexed holograms comprise reflective holograms, e.g., for use in a free-space arrangement. As mentioned above, in some examples, the multiplexed holograms may comprise optical power.

In some embodiments, the methods and processes described herein may be tied to a computing system of one or more computing devices. In particular, such methods and processes may be implemented as a computer-application program or service, an application-programming interface (API), a library, and/or other computer-program product.

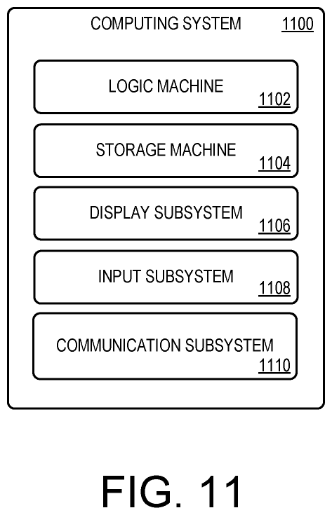

FIG. 11 schematically shows a non-limiting embodiment of a computing system 1100 that can enact one or more of the methods and processes described above. Computing system 1100 is shown in simplified form. Computing system 1100 may take the form of one or more personal computers, server computers, tablet computers, home-entertainment computers, network computing devices, gaming devices, mobile computing devices, mobile communication devices (e.g., smart phone), HMD devices (e.g., HMD device 100, HMD device 200), and/or other computing devices.

Computing system 1100 includes a logic machine 1102 and a storage machine 1104. Computing system 1100 may optionally include a display subsystem 1106, input subsystem 1108, communication subsystem 1110, and/or other components not shown in FIG. 11.

Logic machine 1102 includes one or more physical devices configured to execute instructions. For example, the logic machine may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

The logic machine may include one or more processors configured to execute software instructions. Additionally or alternatively, the logic machine may include one or more hardware or firmware logic machines configured to execute hardware or firmware instructions. Processors of the logic machine may be single-core or multi-core, and the instructions executed thereon may be configured for sequential, parallel, and/or distributed processing. Individual components of the logic machine optionally may be distributed among two or more separate devices, which may be remotely located and/or configured for coordinated processing. Aspects of the logic machine may be virtualized and executed by remotely accessible, networked computing devices configured in a cloud-computing configuration.

Storage machine 1104 includes one or more physical devices configured to hold instructions executable by the logic machine to implement the methods and processes described herein. When such methods and processes are implemented, the state of storage machine 1104 may be transformed—e.g., to hold different data.

Storage machine 1104 may include removable and/or built-in devices. Storage machine 1104 may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage machine 1104 may include volatile, nonvolatile, dynamic, static, read/write, read-only, random-access, sequential-access, location-addressable, file-addressable, and/or content-addressable devices.

It will be appreciated that storage machine 1104 includes one or more physical devices. However, aspects of the instructions described herein alternatively may be propagated by a communication medium (e.g., an electromagnetic signal, an optical signal, etc.) that is not held by a physical device for a finite duration.

Aspects of logic machine 1102 and storage machine 1104 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

When included, display subsystem 1106 may be used to present a visual representation of data held by storage machine 1104. This visual representation may take the form of a graphical user interface (GUI). As the herein described methods and processes change the data held by the storage machine, and thus transform the state of the storage machine, the state of display subsystem 1106 may likewise be transformed to visually represent changes in the underlying data. Display subsystem 1106 may include one or more display devices utilizing virtually any type of technology. Such display devices may be combined with logic machine 1102 and/or storage machine 1104 in a shared enclosure (e.g., in HMD device 100), or such display devices may be peripheral display devices.

When included, input subsystem 1108 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker (e.g., eye tracking systems 300, 400, 500, 600, or 700), accelerometer, and/or gyroscope for motion detection and/or intent recognition; as well as electric-field sensing componentry for assessing brain activity.

When included, communication subsystem 1110 may be configured to communicatively couple computing system 1100 with one or more other computing devices. Communication subsystem 1110 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 1100 to send and/or receive messages to and/or from other devices via a network such as the Internet.

Another example provides a head-mounted display device comprising a see-through display system comprising a transparent combiner having an array of diffractive elements, and an eye tracking system comprising one or more light sources configured to direct light toward an eyebox of the see-through display system, and also comprising an eye tracking camera, wherein the array of diffractive elements comprises a plurality of multiplexed diffractive elements configured to direct images of a respective plurality of different perspectives of the eyebox toward the eye tracking camera. In some such examples, the array of diffractive elements comprises optical power, and the plurality of multiplexed diffractive elements each is configured to collimate a respective image. Additionally or alternatively, in some examples the transparent combiner comprises a waveguide configured to direct incoupled light toward the eye tracking camera, and the multiplexed diffractive elements comprise transmissive diffractive elements configured to incouple image light into the waveguide. Additionally or alternatively, in some examples the multiplexed diffractive elements comprise reflective diffractive elements. Additionally or alternatively, in some examples an angular selectivity of one or more of the multiplexed diffractive elements varies across the eyebox. Additionally or alternatively, in some examples the images of the respective plurality of different perspectives are incident on an image sensor of the eye tracking camera in an overlapping arrangement. Additionally or alternatively, in some examples the head-mounted display device further comprises a logic machine and a storage machine storing instructions executable by the logic machine to receive image data acquired by the eye tracking camera, and input the image data into a trained machine learning function. Additionally or alternatively, in some examples the array of diffractive elements is further configured to direct an image to a plurality of locations on an image sensor of the eye tracking camera. Additionally or alternatively, in some examples the multiplexed diffractive elements further comprise one or more diffractive elements configured to form virtual light sources from the one or more light sources, a number of virtual light sources being greater than a number of light sources in the one or more light sources. Additionally or alternatively, in some examples the head-mounted display device further comprises a waveguide configured to direct light from the one or more light sources to the multiplexed diffractive elements.

Another example provides a head-mounted display device comprising a see-through display system comprising a transparent combiner, the transparent combiner comprising an array of diffractive elements, and an eye tracking system comprising an eye tracking camera configured to receive one or more images of an eyebox of the see-through display system, and the eye tracking system also comprising a light source configured to output light toward the array of diffractive elements, wherein the array of diffractive elements comprises a plurality of multiplexed diffractive elements configured to direct the light from the light source toward the eyebox from a respective plurality of different perspectives. In some such examples the plurality of multiplexed diffractive elements comprise reflective diffractive elements. Additionally or alternatively, in some examples the head-mounted display device further comprises a waveguide integrated with the transparent combiner, the waveguide configured to transmit light from the light source to the plurality of multiplexed diffractive elements, and the plurality of multiplexed diffractive elements comprise transmissive diffractive elements. Additionally or alternatively, in some examples the light source comprises one or more lasers. Additionally or alternatively, in some examples the one or more lasers comprises one or more vertical-cavity surface-emitting lasers.

Another example provides a head-mounted display device comprising a see-through display system comprising a transparent combiner and a waveguide, and an eye tracking system comprising one or more light sources configured to direct light toward an eyebox of the see-through display system, an eye tracking camera comprising an image sensor, and an array of diffractive elements included on the transparent combiner, the array of diffractive elements comprising a plurality of multiplexed diffractive elements configured to direct images of a first perspective of the eyebox to a plurality of spatially separated locations on the image sensor of the eye tracking camera. In some such examples the plurality of multiplexed diffractive elements comprise an angular selectivity of 15° or less. Additionally or alternatively, in some examples the plurality of multiplexed diffractive elements are further configured to direct a plurality of images of a second perspective of the eyebox to the image sensor. Additionally or alternatively, in some examples the array of diffractive elements is a transmissive array of diffractive elements. Additionally or alternatively, in some examples the array of diffractive elements is located on a waveguide.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A head-mounted display device comprising:
a see-through display system comprising a transparent combiner having an array of diffractive elements; and
an eye tracking system comprising one or more light sources configured to direct light toward an eyebox of the see-through display system, and also comprising an eye tracking camera,
wherein the array of diffractive elements comprises a plurality of multiplexed diffractive elements configured to direct images of a respective plurality of different perspectives of the eyebox toward the eye tracking camera.

2. The head-mounted display device of claim 1, wherein the array of diffractive elements comprises optical power, and the plurality of multiplexed diffractive elements each is configured to collimate a respective image.

3. The head-mounted display device of claim 1, wherein the transparent combiner comprises a waveguide configured to direct incoupled light toward the eye tracking camera, and wherein the multiplexed diffractive elements comprise transmissive diffractive elements configured to incouple image light into the waveguide.

4. The head-mounted display device of claim 1, wherein the multiplexed diffractive elements comprise reflective diffractive elements.

5. The head-mounted display device of claim 1, wherein an angular selectivity of one or more of the multiplexed diffractive elements varies across the eyebox.

6. The head-mounted display device of claim 1, wherein the images of the respective plurality of different perspectives are incident on an image sensor of the eye tracking camera in an overlapping arrangement.

7. The head-mounted display device of claim 6, further comprising:
a logic machine; and
a storage machine storing instructions executable by the logic machine to:
receive image data acquired by the eye tracking camera, and
input the image data into a trained machine learning function.

8. The head-mounted display device of claim 1, wherein the array of diffractive elements is further configured to direct an image to a plurality of locations on an image sensor of the eye tracking camera.

9. The head-mounted display device of claim 1, wherein the multiplexed diffractive elements further comprise one or more diffractive elements configured to form virtual light sources from the one or more light sources, a number of virtual light sources being greater than a number of light sources in the one or more light sources.

10. The head-mounted display device of claim 9, further comprising a waveguide configured to direct light from the one or more light sources to the multiplexed diffractive elements.

11. A head-mounted display device comprising:
a see-through display system comprising a transparent combiner, the transparent combiner comprising an array of diffractive elements; and
an eye tracking system comprising an eye tracking camera configured to receive one or more images of an eyebox of the see-through display system, and the eye tracking system also comprising a light source configured to output light toward the array of diffractive elements,
wherein the array of diffractive elements comprises a plurality of multiplexed diffractive elements configured to direct the light from the light source toward the eyebox from a respective plurality of different perspectives.

12. The head-mounted display device of claim 11, wherein the plurality of multiplexed diffractive elements comprise reflective diffractive elements.

13. The head-mounted display device of claim 11, further comprising a waveguide integrated with the transparent combiner, the waveguide configured to transmit light from the light source to the plurality of multiplexed diffractive elements, and wherein the plurality of multiplexed diffractive elements comprise transmissive diffractive elements.

14. The head-mounted display device of claim 11, wherein the light source comprises one or more lasers.

15. The head-mounted display device of claim 14, wherein the one or more lasers comprises one or more vertical-cavity surface-emitting lasers.

16. A head-mounted display device comprising:
a see-through display system comprising a transparent combiner and a waveguide; and
an eye tracking system comprising
one or more light sources configured to direct light toward an eyebox of the see-through display system,
an eye tracking camera comprising an image sensor, and
an array of diffractive elements included on the transparent combiner, the array of diffractive elements comprising a plurality of multiplexed diffractive elements configured to direct images of a first perspective of the eyebox to a plurality of spatially separated locations on the image sensor of the eye tracking camera.

17. The head-mounted display device of claim 16, wherein the plurality of multiplexed diffractive elements comprise an angular selectivity of 15° or less.

18. The head-mounted display device of claim 16, wherein the plurality of multiplexed diffractive elements are further configured to direct a plurality of images of a second perspective of the eyebox to the image sensor.

19. The head-mounted display device of claim 18, wherein the array of diffractive elements is a transmissive array of diffractive elements.

20. The head-mounted display device of claim 19, wherein the array of diffractive elements is located on a waveguide.
